(19) United States
(12) Patent Application Publication
(10) Pub. No.: US 2025/0363982 A1
(43) Pub. Date: Nov. 27, 2025

(54) METHOD FOR TRAINING SPEECH RECOGNITION MODEL, NON-TRANSITORY COMPUTER-READABLE STORAGE MEDIUM, AND ELECTRONIC DEVICE

(71) Applicant: JINGDONG TECHNOLOGY INFORMATION TECHNOLOGY CO., LTD., Beijing (CN)

(72) Inventor: Li FU, Beijing (CN)

(73) Assignee: JINGDONG TECHNOLOGY INFORMATION TECHNOLOGY CO., LTD., Beijing (CN)

(21) Appl. No.: 18/873,755

(22) PCT Filed: Feb. 13, 2023
(86) PCT No.: PCT/CN2023/075729

§ 371 Date: Dec. 11, 2024

(30) Foreign Application Priority Data
Jul. 14, 2022 (CN) 202210833610.4

(51) Int. Cl. G10L 15/06; G10L 15/16

(52) U.S. Cl. CPC G10L 15/063; G10L 15/16

(57) ABSTRACT

A method for training a speech recognition model, includes: constructing an initial speech recognition model including a first network having a first initial parameter and a second network having a second initial parameter; fixing the second initial parameter, calculating a contrastive learning loss function, and performing self-supervised training on the first network according to the contrastive learning loss function to adjust the first initial parameter to a first intermediate parameter; fixing the first intermediate parameter, calculating a first joint loss function, and performing training on the second network according to the first joint loss function to adjust the second initial parameter to a second intermediate parameter; and calculating a second joint loss function, and performing training an the first network and the second network according to the second joint loss function to adjust the first intermediate parameter and the second intermediate parameter to obtain a target speech recognition model.

### CROSS REFERENCE TO RELATED APPLICATIONS

The present application is a U.S. National Stage of International Application No. PCT/CN2023/075729, filed on Feb. 13, 2023, and claims the priority of Chinese Patent Application No. 202210833610.4 entitled “Method for training speech recognition model, apparatus, storage medium, and electronic device”, filed on Jul. 14, 2022, the content of both of which is incorporated herein by reference in its entirety.

### TECHNICAL FIELD

The present disclosure relates to the field of speech recognition, and in particular, to a method for training a speech recognition model, an apparatus for training a speech recognition model, a non-transitory computer-readable storage medium, and an electronic device.

### BACKGROUND

In recent years, with the high-speed development of deep learning technologies, automatic speech recognition (ASR) based on an end-to-end deep neural network has gradually evolved into a mainstream technology in the field of current speech recognition.

It should be noted that the information disclosed in the above background part is only used to enhance the understanding of the background of the present disclosure, and therefore may include information that does not constitute the related art known to those of ordinary skill in the art.

### SUMMARY

According to an aspect of the present disclosure, there is provided a method for training a speech recognition model, including: constructing an initial speech recognition model, where the initial speech recognition model includes a first network having a first initial parameter and a second network having a second initial parameter; fixing the second initial parameter, calculating a contrastive learning loss function based on an unlabeled data set, and performing self-supervised training on the first network according to the contrastive learning loss function to adjust the first initial parameter to a first intermediate parameter; fixing the first intermediate parameter, calculating a first joint loss function based on a labeled data set, and performing training on the second network according to the first joint loss function to adjust the second initial parameter to a second intermediate parameter; and calculating a second joint loss function based on the labeled data set, and performing training on the first network and the second network according to the second joint loss function to adjust the first intermediate parameter and the second intermediate parameter to obtain a target speech recognition model. According to a second aspect of the embodiments of the present disclosure, there is provided a non-transitory computer-readable storage medium having a computer program stored thereon; when the program is executed by a processor, the method for training the speech recognition model in the foregoing embodiments is implemented.

According to a third aspect of the embodiments of the present disclosure, there is provided an electronic device, including: one or more processors; and a storage device, configured to store one or more programs; when the one or more programs are executed by the one or more processors, the one or more processors are enabled to implement the method for training the speech recognition model in the foregoing embodiments.

It is to be understood that both the foregoing general description and the following detailed description are exemplary and explanatory only, and are not restrictive of the present disclosure.

### BRIEF DESCRIPTION OF THE DRAWINGS

The accompanying drawings, which are incorporated in and constitute a part of the description, illustrate embodiments consistent with the disclosure and together with the description serve to explain the principles of the disclosure. Obviously, the drawings in the following description are some embodiments of the present disclosure, and for those of ordinary skill in the art, other drawings can also be obtained from these drawings without creative efforts. In the drawings:

FIG. 1 schematically shows a schematic flowchart of a method for training a speech recognition model according to some embodiments of the present disclosure;

FIG. 2 schematically shows a schematic flowchart of a method for preparing a training data set according to some embodiments of the present disclosure;

FIG. 3 schematically shows a schematic flowchart of a method for calculating a contrastive learning loss function according to some embodiments of the present disclosure;

FIG. 4 schematically shows a schematic flowchart of a mask processing method according to some embodiments of the present disclosure;

FIG. 5 schematically shows a schematic flowchart of another method for calculating a contrastive learning loss function according to some embodiments of the present disclosure;

FIG. 6 schematically shows a schematic composition diagram of an apparatus for training a speech recognition model according to some embodiments of the present disclosure;

FIG. 7 schematically shows a schematic diagram of a non-transitory computer-readable storage medium according to some embodiments of the present disclosure;

FIG. 8 schematically shows a schematic structural diagram of a computer system of an electronic device according to some embodiments of the present disclosure.

### DETAILED DESCRIPTION

Example embodiments will now be described more fully with reference to the accompanying drawings. Example embodiments, however, can be implemented in various forms and should not be construed as limited to the embodiments set forth herein; by contrast, these embodiments are provided so that the present disclosure will be thorough and complete, and will fully convey the concept of example embodiments to those skilled in the art.

Furthermore, the described features, structures, or characteristics may be combined in any suitable manner in one or more embodiments. In the following description, numerous specific details are provided to give a thorough understanding of the embodiments of the present disclosure. However, those skilled in the art will appreciate that the technical solutions of the present disclosure may be practiced without one or more of the specific details, or other methods, components, devices, steps, or the like may be employed. In other instances, common general known methods, apparatuses, implementations, or operations are not shown or described in detail to avoid obscuring aspects of the present disclosure.

The block diagrams shown in the accompanying drawings are merely functional entities and do not necessarily correspond to physically independent entities. That is, these functional entities may be implemented in the form of software, or implemented in one or more hardware modules or integrated circuits, or implemented in different networks and/or processor apparatuses and/or microcontroller apparatuses.

The flowcharts shown in the accompanying drawings are merely exemplary descriptions, and do not necessarily include all content and operations/steps, and are not necessarily performed in the described order. For example, some operations/steps may also be decomposed, and some operations/steps may be combined or partially combined, thus the actual execution order may be changed according to actual situations.

Since the parameter quantity of the end-to-end ASR model is large, the performance of the model often depends on a large amount of labeled data. In addition, in general, the self-supervised ASR method is mainly performed under a connectionist temporal classification (CTC) framework; and in the CTC framework, it is assumed that the speech feature representation frames are independent from each other, which is inconsistent with the actual situation, and the performance is limited. Therefore, it is needed to further improve the recognition performance of the speech recognition model under the condition of insufficient labeled data.

Implementation details of the technical solutions of the embodiments of the present disclosure are described in detail below.

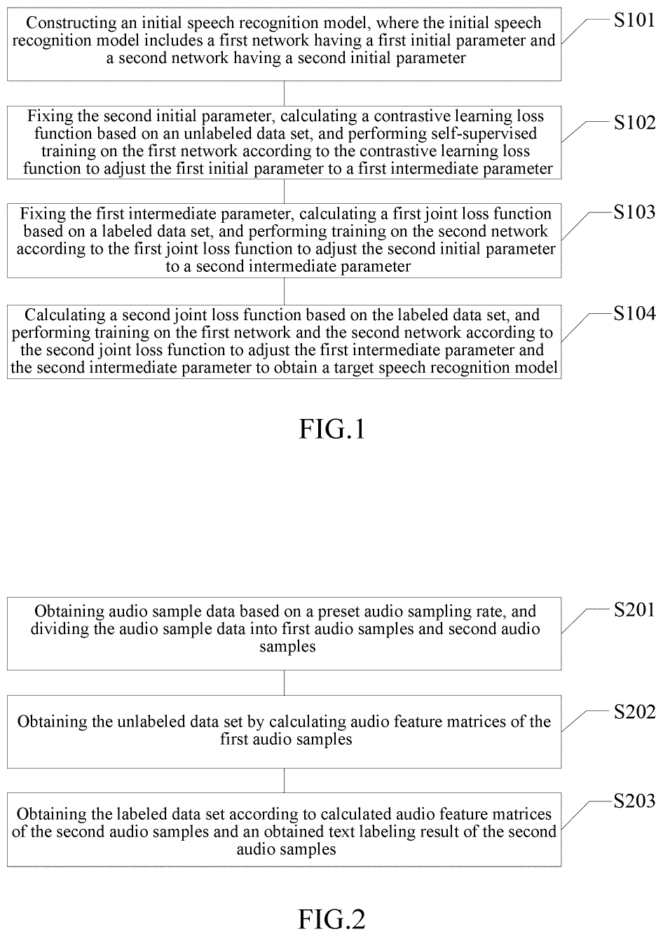

FIG. 1 schematically shows a schematic flowchart of a method for training a speech recognition model according to some embodiments of the present disclosure. As shown in FIG. 1, the method for training the speech recognition model includes steps S101 to S104.

In step S101, an initial speech recognition model is constructed, where the initial speech recognition model includes a first network having a first initial parameter and a second network having a second initial parameter.

In step S102, the second initial parameter is fixed, a contrastive learning loss function is calculated based on an unlabeled data set, and self-supervised training is performed on the first network according to the contrastive learning loss function to adjust the first initial parameter to a first intermediate parameter.

In step S103, the first intermediate parameter is fixed, a first joint loss function is calculated based on a labeled data set, and training is performed on the second network according to the first joint loss function to adjust the second initial parameter to a second intermediate parameter.

In step S104, a second joint loss function is calculated based on the labeled data set, and training is performed on the first network and the second network according to the second joint loss function to adjust the first intermediate parameter and the second intermediate parameter to obtain a target speech recognition model.

In the technical solution provided by some embodiments of the present disclosure, firstly, on the basis of the initial speech recognition model, a contrastive learning loss function is designed by using the unlabeled data set to perform pre-training on the first network of the model; then, the parameter of the first network is fixed, and a joint loss function is calculated by using the labeled data set to perform training on the second network of the model; and finally, a joint loss function is calculated by using the labeled data to perform training on the speech recognition model, so as to perform fine adjustment on parameters of the first network and the second network, and perform training on the model until convergence to obtain a final speech recognition model. According to the method for training the speech recognition model of the present disclosure, on one hand, the training process does not reley on a large amount of labeled data, so that the labeled data cost of the automatic speech recognition ASR is reduced, and the research and development as well as optimization progress of the speech recognition model is improved; on the other hand, the model training process is not limited by the connectionist temporal classification (CTC) framework, so that it is avoided that the speech feature representation frames are independent from each other, and it is more in line with the actual situation, thus the recognition accuracy of the speech recognition model is higher.

The various steps of the method for training the speech recognition model in the example embodiment will be described in more detail below with reference to the accompanying drawings and embodiments.

In step S101, an initial speech recognition model is constructed, where the initial speech recognition model includes a first network having a first initial parameter and a second network having a second initial parameter.

In an embodiment of the present disclosure, a randomly initialized speech recognition model is constructed firstly. The network structure of the speech recognition model may include an embedding layer, a transformer layer, and an output layer, where the transformer layer is composed of a first network and a second network, the first network is an encoder network, and the second network is a decoder network.

For the initial speech recognition model after being randomly initialized, both the first network and the second network have respective initial parameters, and the network model parameters are adjusted in subsequent model training to obtain the trained speech recognition model.

In an embodiment of the present disclosure, before training of steps S102 to S104, a data set for training needs to be prepared. FIG. 2 schematically shows a schematic flowchart of a method for preparing a training data set according to some embodiments of the present disclosure. As shown in FIG. 2, the method for preparing the training data set includes following steps.

In step S201, audio sample data is obtained based on a preset audio sampling rate, and the audio sample data is divided into first audio samples and second audio samples.

In step S202, the unlabeled data set is obtained by calculating audio feature matrices of the first audio samples.

In step S203, the labeled data set is obtained according to calculated audio feature matrices of the second audio samples and an obtained text labeling result of the second audio samples.

In step S201, the audio sample data is obtained by performing audio sampling according to a preset audio sampling rate, and the sampled audio may be Chinese speech audio or other language audio. For example, an audio sample with a duration is obtained by performing sampling according to an audio sampling rate of 16 kHz.

Then, in order to configure the unlabeled data set and the labeled data set, the sampled audio sample data may be divided into two parts. One part is used for generating the unlabeled data set, and there are i samples in total; and the other part is used for generating the labeled data set, and there are j samples in total.

It should be noted that, in the division process, some audio samples may be used as both the first audio samples and the second audio samples, that is, the contents of which may have an overlapping part.

In step S202, the unlabeled data set is generated. For the unlabeled data set, the speech does not need to be labeled. Therefore, the audio feature matrices of the first audio samples are directly calculated to obtain the unlabeled data set, which is denoted as U={xi|iϵ[1, Nu]}, where xi is the audio feature matrix of the i-th first audio sample, and Nu is the quantity of unlabeled first audio samples in the unlabeled data set.

In step S203, the labeled data set is generated. In the labeled data set, each audio sample has its corresponding text labeling result. Therefore, by obtaining the text labeling result through calculating the audio feature matrices of the second audio samples and labeling the second audio samples, the labeled data set may be obtained, which is denoted as L={xj, yj|jϵ[1, Nl]}, where xj is the audio feature matrix of the j-th second audio sample, yj is the text labeling result corresponding to the audio feature matrix xj, and Nl is the quantity of unlabeled second audio samples in the unlabeled data set.

It should be noted that the size relationship between the quantity Nu of the unlabeled data set and the quantity Nl of the labeled data set is not limited in the present disclosure. However, in an actual operation process, considering the speech labeling cost, the quantity of the unlabeled data set may be far greater than the quantity of the labeled data set, that is, Nu>>Nl. For example, the unlabeled data set and the labeled data set are respectively 10000 hours and 100 hours.

In steps S202 and S203, when the audio feature matrix of the audio sample is calculated, the audio feature matrix may be an 80-dimensional Mel-spectrogram feature, where the duration of each frame of the spectrogram is 25 ms, and the step size is 10 ms.

In step S102, the second initial parameter is fixed, a contrastive learning loss function is calculated based on an unlabeled data set, and self-supervised training is performed on the first network according to the contrastive learning loss function to adjust the first initial parameter to a first intermediate parameter.

In an embodiment of the present disclosure, step S102 is to perform self-supervised training on the first network, and the first network includes a convolutional neural network module and a convolutional enhancement module.

Among them, the first network may be an encoder network, and includes a convolutional neural network module (i.e., a CNN module) and a convolutional enhancement module (i.e., a conformer module). For example, the encoder network is formed by successively connecting 5 layers of CNN modules and 12 conformer modules.

FIG. 3 schematically shows a schematic flowchart of a method for calculating a contrastive learning loss function according to some embodiments of the present disclosure. As shown in FIG. 3, the method for calculating the contrastive learning loss function includes steps S301 to S304.

In step S301, a shallow representation result of a piece of audio sample data in the unlabeled data set is calculated based on the convolutional neural network module.

In step S302, mask processing is performed on the shallow representation result to obtain a mask representation result, and a deep representation result of the mask representation result is calculated based on the convolutional enhancement module.

In step S303, linear transformation is performed on the shallow representation result to obtain a target representation result.

In step S304, the contrastive learning loss function is calculated based on the deep representation result and the target representation result.

Step S301 to step S304 are described in detail below.

In step S301, a shallow representation result of a piece of audio sample data in the unlabeled data set is calculated based on the convolutional neural network module.

In some embodiments, for the given audio sample data xi EU in the unlabeled data set, the shallow representation result is obtained by performing multi-layer CNN calculation on xi, which is denoted as e.

Then, the shallow representation result e is respectively processed in two manners, i.e., the two processes in step S302 and step S301; and then, the processing results in such two manners are compared.

In step S302, mask processing is performed on the shallow representation result to obtain a mask representation result, and a deep representation result of the mask representation result is calculated based on the convolutional enhancement module.

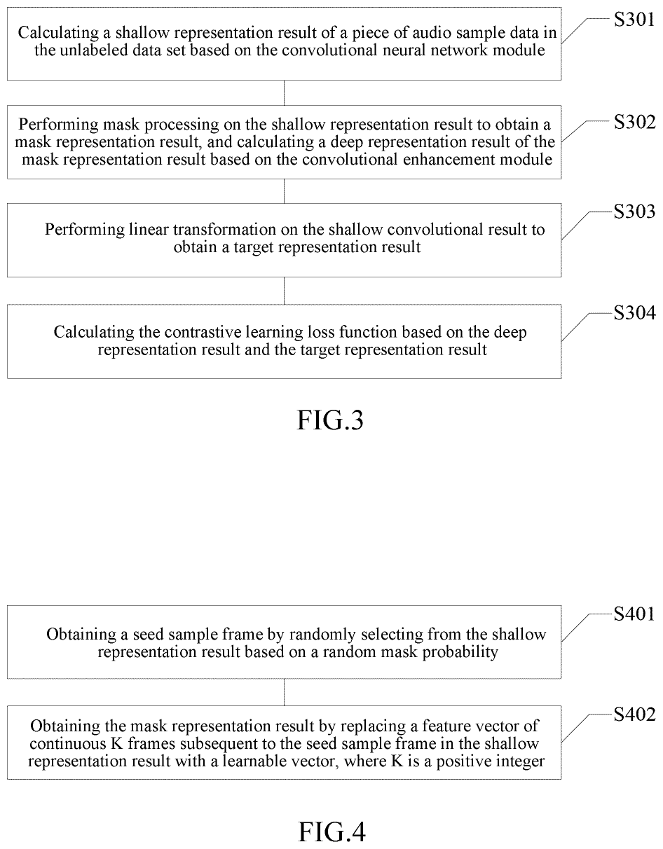

FIG. 4 schematically shows a schematic flowchart of a mask processing method according to some embodiments of the present disclosure. As shown in FIG. 4, the mask processing method includes following steps.

In step S401, a seed sample frame is obtained by randomly selecting from the shallow representation result based on a random mask probability.

In step S402, the mask representation result is obtained by replacing a feature vector of continuous K frames subsequent to the seed sample frame in the shallow representation result with a learnable vector, where K is a positive integer.

In some embodiments, p-percent sample frames are randomly selected from the shallow representation result e as the seed sample frame, and mask processing is performed on the continuous K frames following the seed sample frame in e, that is, a learnable vector is used to replace the feature vector of the mask position in the shallow representation e to obtain the mask representation result e.

Among them, p is a random mask probability, and is a preset value, for example, p=6.5. K is a continuous frame mask parameter. K is also a preset value, and is a positive integer, for example, K=10. Of course, the embodiments of the present disclosure are merely exemplary descriptions, and the values of the random mask probability and the continuous frame mask parameter may be adaptively adjusted according to actual requirements.

After the mask representation result e is obtained, the deep representation result may be obtained through calculation by a plurality of conformer modules, which is denoted as h.

In step S303, linear transformation is performed on the shallow representation result to obtain a target representation result.

In some embodiments, the linear transformation (i.e., a linear map), is a mapping from a vector space V to another vector space W in which an addition operation and a quantity multiplication operation are maintained. The shallow representation result e is subjected to a linear transformation to obtain a target representation result, which is denoted as q.

In step S304, the contrastive learning loss function is calculated based on the deep representation result and the target representation result.

FIG. 5 schematically shows a schematic flowchart of another method for calculating a contrastive learning loss function according to some embodiments of the present disclosure.

As shown in FIG. 5, the method for calculating the contrastive learning loss function includes following steps.

In step S501, M frames of anchor samples are selected from a mask portion in the deep representation result as first samples, where M is a positive integer.

In step S502, M frames anchor samples in one-to-one correspondence with the M frames of anchor samples in the first samples from the target representation result as second samples, and S frames of negative samples are selected as third samples, where S is a positive integer.

In step S503, the contrastive learning loss function is calculated based on a similarity between the first samples and the second samples and a similarity between the first samples and the third samples.

In some embodiments, M frames of anchor samples are selected from the mask portion in the deep representation result h, and each frame of samples (i.e., the first samples) are denoted as hm. M is the number of frames of the anchor samples, is a preset value and is a positive integer.

For example, the number of frames of the anchor samples M=10.

In addition, M frames of anchor samples in one-to-one correspondence with the anchor samples in the first samples are selected from the target representation result q, and each frame of samples (i.e., the second samples) are denoted as qm. Meanwhile, S frames of negative samples are selected from the target representation result q, and each frame of samples (i.e., the third samples) are denoted as \tilde{q}ₛ. S is the number of frames of the negative samples, is a preset value and is a positive integer. For example, the number of frames of the negative samples S=100.

Then, the contrastive learning loss function lossᵢ of the audio samples xi is calculated, as shown in formula (1): PG

$${loss}_{i} = - log {\sum }_{m = 1}^{M} \frac{exp ( sim ( {h}_{m} , {q}_{m} ) / T )}{exp ( sim ( {h}_{m} , {q}_{m} ) / T ) + {\sum }_{s = 1}^{S} exp ( sim ( {h}_{m} , {\tilde{q}}_{s} ) / T )} \qquad ( 1 )$$

where sim(hₘ,qₘ) represents the similarity between the first samples hm and the second samples qₘ, sim(hₘ,\tilde{q}ₛ), represents the similarity between the first samples hm and the third samples \tilde{q}ₛ, T is a scale factor, and is a preset value. For example, T=10.

In some embodiments, sim( ) is a similar function, and the calculation formula is shown in formula (2):

$$sim ( a , b ) = \frac{{a}^{T} b}{‖ a ‖ ‖ b ‖} \qquad ( 2 )$$

where, a and b are respectively two main bodies, the similarity of which needs to be calculated. For example, when sim(hₘ, qₘ) is calculated, a is the first sample hm, b is the second sample qm. sim(hₘ,\tilde{q}ₛ) is the same.

For each audio sample xi, a contrastive learning loss function lossi may be calculated. Then, for the overall contrastive learning loss functions loss of all unlabeled data sets U, the contrastive learning loss function of each audio sample needs to be integrated, such as being averaged.

Based on the foregoing method, a contrastive learning task is designed; self-supervised training is performed on the first network (the encoder network) in the speech recognition model through the unlabeled data set U; and after the training is completed, the first initial parameter of the encoder network is adjusted to a first intermediate parameter. Since it does not rely on a large amount of labeled data, the labeled data cost of the automatic speech recognition ASR can be reduced, and the research and development as well as optimization progress of the speech recognition model can be improved.

In step S103, the first intermediate parameter is fixed, a first joint loss function is calculated based on a labeled data set, and training is performed on the second network according to the first joint loss function to adjust the second initial parameter to a second intermediate parameter. In an embodiment of the present disclosure, step S103 is to perform training on the second network, and the second network includes a feature deformation module.

Among them, the second network may be a decoder network, and includes one or more feature deformation modules, i.e., transformer modules. For example, the decoder network is composed of six transformer modules.

After step S102, the encoder network has been trained, but the decoder network is still in a randomly initialized state. In order to avoid imbalance between training states of the decoder network and the encoder network, in this step, the decoder network portion is trained by using the joint loss function to achieve the purpose of preliminarily training the decoder network.

In an embodiment of the present disclosure, the decoder network is trained through a joint loss function, and the joint loss function is a CTC-attention joint loss function.

In some embodiments, the loss function used in the current end-to-end ASR model training process mainly includes: (1) a loss function based on connectionist temporal classification (CTC), (2) an encoder-decoder loss function based on an attention mechanism, and (3) a CTC-attention joint loss function. Among them, the CTC-attention joint loss function has respective advantages of CTC and attention mechanisms. Therefore, in the present disclosure, model training is performed by using a CTC-attention joint loss function.

During model training, the labeled data set L is used, and the encoder network is fixed, that is, the first intermediate parameter is fixed. Model training on the decoder network is completed by using the CTC-attention joint loss function, until the decoder network converges, so that the decoder network is adjusted from the second initial parameter to a second intermediate parameter.

In step S104, a second joint loss function is calculated based on the labeled data set, and training is performed on the first network and the second network according to the second joint loss function to adjust the first intermediate parameter and the second intermediate parameter to obtain a target speech recognition model.

In an embodiment of the present disclosure, step S104 is to perform fine adjustment on the parameters of the two networks in the speech recognition model. The loss function is still the used CTC-attention joint loss function.

In some embodiments, the labeled data set L is used, the encoder network and the decoder network are opened, and fine adjustment training is performed on the encoder network and the decoder network by optimizing the CTC-attention joint loss function until the model converges, so as to adjust the first intermediate parameter and the second intermediate parameter to obtain the final speech recognition model.

Based on the method for training the speech recognition model provided in the present disclosure, the model training process is not limited by the connectionist temporal classification (CTC) framework, so that it is avoided that the speech feature representation frames are independent from each other, and it is more in line with the actual situation, thus the recognition accuracy of the speech recognition model is higher.

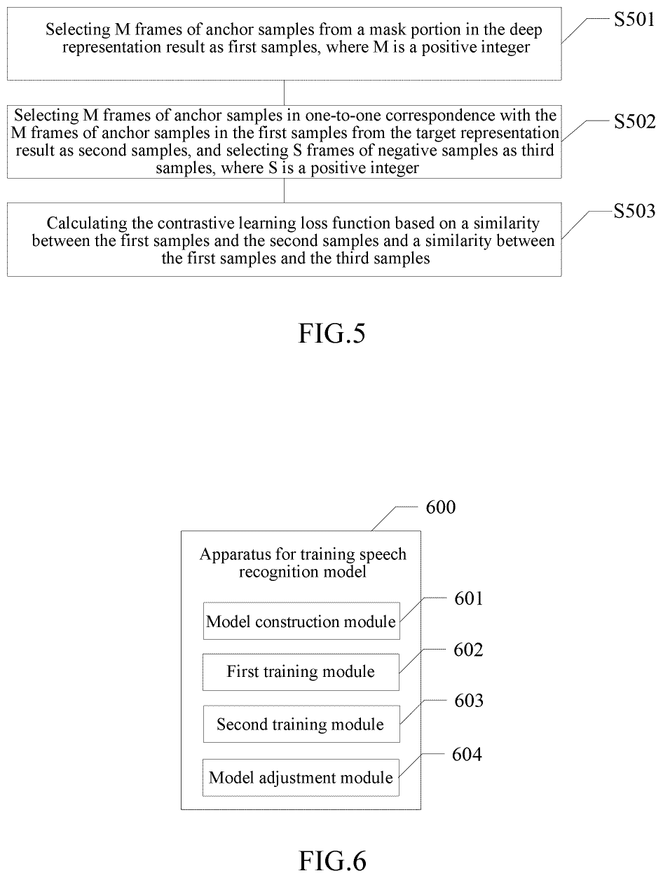

FIG. 6 schematically shows a schematic composition diagram of an apparatus for training a speech recognition model according to some embodiments of the present disclosure. As shown in FIG. 6, the apparatus 600 for training the speech recognition model may include a model construction module 601, a first training module 602, a second training module 603, and a model adjustment module 604.

The model construction module 601 is configured to construct an initial speech recognition model, where the initial speech recognition model includes a first network having a first initial parameter and a second network having a second initial parameter.

The first training module 602 is configured to fix the second initial parameter, calculate a contrastive learning loss function based on an unlabeled data set, and perform self-supervised training on the first network according to the contrastive learning loss function to adjust the first initial parameter to a first intermediate parameter.

The second training module 603 is configured to fix the first intermediate parameter, calculate a first joint loss function based on a labeled data set, and perform training on the second network according to the first joint loss function to adjust the second initial parameter to a second intermediate parameter.

The model adjustment module 607 is configured to calculate a second joint loss function based on the labeled data set, and performing training on the first network and the second network according to the second joint loss function to adjust the first intermediate parameter and the second intermediate parameter to obtain a target speech recognition model.

According to some embodiments of the present disclosure, the first network includes a convolutional neural network module and a convolutional enhancement module.

According to some embodiments of the present disclosure, the first training module 602 includes a shallow unit, a mask unit, a target unit, and a comparison unit. The shallow unit is configured to calculate a shallow representation result of a piece of audio sample data in the unlabeled data set based on the convolutional neural network module. The mask unit is configured to perform mask processing on the shallow representation result to obtain a mask representation result, and calculate a deep representation result of the mask representation result based on the convolutional enhancement module. The target unit is configured to perform linear transformation on the shallow representation result to obtain a target representation result.

The comparison unit is configured to calculate the contrastive learning loss function based on the deep representation result and the target representation result.

According to some embodiments of the present disclosure, the mask unit is further configured to: obtain a seed sample frame by randomly selecting from the shallow representation result based on a random mask probability; and obtain the mask representation result by replacing a feature vector of continuous K frames subsequent to the seed sample frame in the shallow representation result with a learnable vector, where K is a positive integer.

According to some embodiments of the present disclosure, the comparison unit is further configured to: select M frames of anchor samples from a mask portion in the deep representation result as first samples, where M is a positive integer; select M frames of anchor samples in one-to-one correspondence with the M frames of anchor samples in the first samples from the target representation result as second samples; select S frames of negative samples as third samples, where S is a positive integer; and calculate the contrastive learning loss function based on a similarity between the first samples and the second samples and a similarity between the first samples and the third samples.

According to some embodiments of the present disclosure, the second network includes a feature deformation module.

According to some embodiments of the present disclosure, the apparatus 600 for training the speech recognition model further includes a data preparation module, configured to: obtain audio sample data based on a preset audio sampling rate, and divide the audio sample data into first audio samples and second audio samples; obtain the unlabeled data set by calculating audio feature matrices of the first audio samples; and obtain the labeled data set according to calculated audio feature matrices of the second audio samples and an obtained text labeling result of the second audio samples.

Specific details of the modules in the apparatus 600 for training the speech recognition model have been described in detail in the corresponding method for training the speech recognition model, and details are not described here again.

It should be noted that although several modules or units of the device for action execution are mentioned in the above detailed description, such division is not mandatory. In fact, according to embodiments of the present disclosure, the features and functions of two or more modules or units described above may be embodied in one module or unit. By contrast, the features and functions of one module or unit described above may be further divided into a plurality of modules or units.

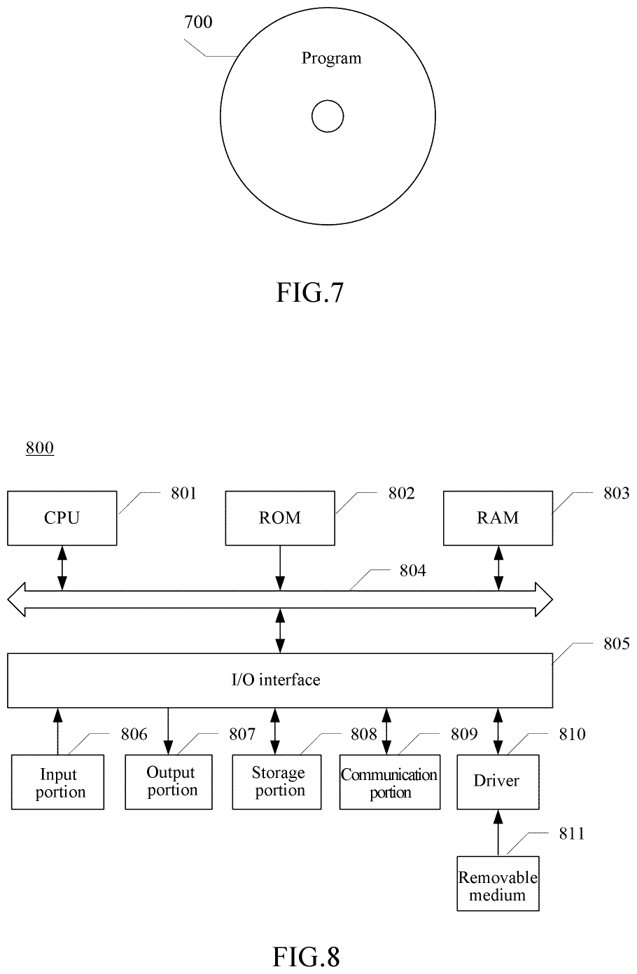

In some embodiments of the present disclosure, there is further provided a non-transitory computer-readable storage medium capable of implementing the above method. FIG. 7 schematically shows a schematic diagram of a non-transitory computer-readable storage medium according to some embodiments of the present disclosure. As shown in FIG. 7, it describes a program product 700 for implementing the above method according to an embodiment of the present disclosure, which may adopt a portable compact disk read-only memory (CD-ROM) and include program code, and may run on a terminal device, such as on a mobile phone. However, the program product of the present disclosure is not limited to this.

In the present document, the readable storage medium may be any tangible medium containing or storing a program, and the program may be used by or in combination with an instruction execution system, apparatus or device.

In some embodiments of the present disclosure, there is further provided an electronic device capable of implementing the above method. FIG. 8 schematically shows a schematic structural diagram of a computer system of an electronic device according to some embodiments of the present disclosure.

It should be noted that the computer system 800 of the electronic device shown in FIG. 8 is merely an example, and should not bring any limitation to the function and usage scope of the embodiments of the present disclosure.

As shown in FIG. 8, the computer system 800 includes a central processing unit (CPU) 801, which may perform various appropriate actions and processing according to a program stored in a read-only memory (ROM) 802 or a program loaded into a random access memory (RAM) 803 from a storage portion 808. In the RAM 803, various programs and data required for system operation are also stored. The CPU 801, the ROM 802 and the RAM 803 are connected to each other through a bus 804. An input/output (I/O) interface 805 is also connected to the bus 804.

The following components are connected to I/O interface 805: an input portion 806 including a keyboard, a mouse, etc.; an output portion 807 including a cathode ray tube (CRT), a liquid crystal display (LCD), and a speaker, etc.; a storage portion 808 including a hard disk; and a communication portion 809 including a network interface card, such as a LAN (Local Area Network) card, a modem, etc. The communication portion 809 performs communication processing via a network such as the Internet. The driver 810 is also connected to the I/O interface 805 as needed. A removable medium 811, such as a magnetic disk, an optical disk, a magneto-optical disk, a semiconductor memory, etc., is installed on the driver 810 as needed, so that a computer program read from the removable medium 811 is installed into the storage portion 808 as needed.

In particular, according to embodiments of the present disclosure, the process described below with reference to the flowchart may be implemented as a computer software program. For example, an embodiment of the present disclosure includes a computer program product, which includes a computer program carried on a computer-readable medium, and the computer program includes program code for executing the method shown in the flowchart. In such an embodiment, the computer program may be downloaded from the network through the communication portion 809 and installed, and/or installed from the removable medium 811. When the computer program is executed by the central processing unit (CPU) 801, various functions defined in the system of the present disclosure are executed.

It should be noted that the computer readable medium shown in the embodiments of the present disclosure may be a computer readable signal medium or a computer readable storage medium or any combination of them. The computer readable storage medium may be, for example, but not limited to, an electronic, magnetic, optical, electromagnetic, infrared, or semiconductor system, apparatus, or device, or any combination of them. A more specific example of the computer-readable storage medium may include, but is not limited to, an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any suitable combination of them. In the present disclosure, the computer-readable storage medium may be any tangible medium containing or storing a program, and the program may be used by or in combination with an instruction execution system, apparatus, or device. In the present disclosure, the computer-readable signal medium may include a data signal propagated in a baseband or as a part of a carrier, where the computer-readable program code is carried. The propagated data signal may take a variety of forms, including but not limited to an electromagnetic signal, an optical signal, or any suitable combination of the above. The computer-readable signal medium may also be any computer-readable medium other than a computer-readable storage medium, and the computer-readable medium may send, propagate, or transmit a program for use by or in combination with an instruction execution system, apparatus, or device. The program code included in the computer-readable medium may be transmitted by using any suitable medium, including but not limited to: wireless medium, wired medium, or any suitable combination of the foregoing.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a portion of a module, a program segment, or code, which includes one or more executable instructions for implementing the specified logical functions. It should also be noted that, in some alternative implementations, the functions noted in the blocks may occur in a different order from that noted in the drawings. For example, two blocks shown in succession may, in fact, be executed substantially concurrently, or they may sometimes be executed in the reverse order, which depends upon the functionality involved. It will also be noted that each block of the block diagrams or flowcharts, and combinations of blocks in the block diagrams or flowcharts, can be implemented by special purpose hardware-based systems that perform the specified functions or operations, or by combinations of special purpose hardware and computer instructions.

The units involved in the embodiments of the present disclosure may be implemented by software, or may be implemented by hardware, and the described units may also be disposed in a processor. Among them, names of these units do not constitute a limitation on the unit itself in some cases.

In another aspect, the present disclosure further provides a computer-readable medium, which may be included in the electronic device described in the foregoing embodiments, or may exist alone without being assembled into the electronic device. The computer-readable medium carries one or more programs, and when the one or more programs are executed by the electronic device, the electronic device is enabled to implement the method in the foregoing embodiments.

It should be noted that although several modules or units of the device for action execution are mentioned in the above detailed description, such division is not mandatory. In fact, according to embodiments of the present disclosure, the features and functions of two or more modules or units described above may be embodied in one module or unit. By contrast, the features and functions of one module or unit described above may be further divided into a plurality of modules or units.

Through the description of the foregoing embodiments, those skilled in the art may easily understand that the example embodiments described here may be implemented by software, or may be implemented by software in combination with necessary hardware. Therefore, the technical solutions according to the embodiments of the present disclosure may be embodied in the form of a software product, The software product may be stored in a non-volatile storage medium (which may be a CD-ROM, a USB flash disk, a mobile hard disk, etc.) or a network, and includes several instructions to enable a computing device (which may be a personal computer, a server, a touch terminal, or a network device, etc.) to perform the method according to the embodiments of the present disclosure.

Other embodiments of the present disclosure will be apparent to those skilled in the art from consideration of the description and practice of the invention disclosed here. The present disclosure is intended to cover any variations, uses, or adaptations of the present disclosure following the general principles of the present disclosure and including common general knowledge or conventional technical means in the art not disclosed in the present disclosure.

It should be understood that the present disclosure is not limited to the precise structures that have been described above and shown in the accompanying drawings, and various modifications and changes may be made without departing from the scope of the present disclosure. It is intended that the scope of the present disclosure only is limited by the appended claims.

1. A method for training a speech recognition model, comprising:
constructing an initial speech recognition model, wherein the initial speech recognition model comprises a first network having a first initial parameter and a second network having a second initial parameter;
fixing the second initial parameter, calculating a contrastive learning loss function based on an unlabeled data set, and performing self-supervised training on the first network according to the contrastive learning loss function to adjust the first initial parameter to a first intermediate parameter;
fixing the first intermediate parameter, calculating a first joint loss function based on a labeled data set, and performing training on the second network according to the first joint loss function to adjust the second initial parameter to a second intermediate parameter; and
calculating a second joint loss function based on the labeled data set, and performing training on the first network and the second network according to the second joint loss function to adjust the first intermediate parameter and the second intermediate parameter to obtain a target speech recognition model.

2. The method for training the speech recognition model according to claim 1, wherein the first network comprises a convolutional neural network module and a convolutional enhancement module.

3. The method for training the speech recognition model according to claim 2, wherein calculating the contrastive learning loss function based on the unlabeled data set comprises:
calculating a shallow representation result of a piece of audio sample data in the unlabeled data set based on the convolutional neural network module;
performing mask processing on the shallow representation result to obtain a mask representation result, and calculating a deep representation result of the mask representation result based on the convolutional enhancement module;
performing linear transformation on the shallow representation result to obtain a target representation result; and
calculating the contrastive learning loss function based on the deep representation result and the target representation result.

4. The method for training the speech recognition model according to claim 3, wherein performing mask processing on the shallow representation result to obtain the mask representation result comprises:
obtaining a seed sample frame by randomly selecting from the shallow representation result based on a random mask probability; and
obtaining the mask representation result by replacing a feature vector of continuous K frames subsequent to the seed sample frame in the shallow representation result with a learnable vector, wherein K is a positive integer.

5. The method for training the speech recognition model according to claim 3, wherein calculating the contrastive learning loss function based on the deep representation result and the target representation result comprises:
selecting M frames of anchor samples from a mask portion in the deep representation result as first samples, wherein M is a positive integer;
selecting M frames of anchor samples in one-to-one correspondence with the M frames of anchor samples in the first samples from the target representation result as second samples, and selecting S frames of negative samples as third samples, wherein S is a positive integer; and
calculating the contrastive learning loss function based on a similarity between the first samples and the second samples and a similarity between the first samples and the third samples.

6. The method for training the speech recognition model according to claim 1, wherein the second network comprises a feature deformation module.

7. The method for training the speech recognition model according to claim 1, further comprising:
obtaining audio sample data based on a preset audio sampling rate, and dividing the audio sample data into first audio samples and second audio samples;
obtaining the unlabeled data set by calculating audio feature matrices of the first audio samples; and
obtaining the labeled data set according to calculated audio feature matrices of the second audio samples and an obtained text labeling result of the second audio samples.

8. (canceled)

9. A non-transitory computer-readable storage medium having a computer program stored thereon, wherein when the program is executed by a processor, a method for training a speech recognition model is implemented, and the method for training the speech recognition model comprises:
constructing an initial speech recognition model, wherein the initial speech recognition model comprises a first network having a first initial parameter and a second network having a second initial parameter;
fixing the second initial parameter, calculating a contrastive learning loss function based on an unlabeled data set, and performing self-supervised training on the first network according to the contrastive learning loss function to adjust the first initial parameter to a first intermediate parameter;
fixing the first intermediate parameter, calculating a first joint loss function based on a labeled data set, and performing training on the second network according to the first joint loss function to adjust the second initial parameter to a second intermediate parameter; and
calculating a second joint loss function based on the labeled data set, and performing training on the first network and the second network according to the second joint loss function to adjust the first intermediate parameter and the second intermediate parameter to obtain a target speech recognition model.

10. An electronic device, comprising:
one or more processors; and
a storage apparatus, configured to store one or more programs, wherein when the one or more programs are executed by the one or more processors, the one or more processors are enabled to implement a method for training a speech recognition model, comprising:
constructing an initial speech recognition model, wherein the initial speech recognition model comprises a first network having a first initial parameter and a second network having a second initial parameter;
fixing the second initial parameter, calculating a contrastive learning loss function based on an unlabeled data set, and performing self-supervised training on the first network according to the contrastive learning loss function to adjust the first initial parameter to a first intermediate parameter;
fixing the first intermediate parameter, calculating a first joint loss function based on a labeled data set, and performing training on the second network according to the first joint loss function to adjust the second initial parameter to a second intermediate parameter; and
calculating a second joint loss function based on the labeled data set, and performing training on the first network and the second network according to the second joint loss function to adjust the first intermediate parameter and the second intermediate parameter to obtain a target speech recognition model.

11. The non-transitory computer-readable storage medium according to claim 9, wherein the first network comprises a convolutional neural network module and a convolutional enhancement module.

12. The non-transitory computer-readable storage medium according to claim 11, wherein calculating the contrastive learning loss function based on the unlabeled data set comprises:
calculating a shallow representation result of a piece of audio sample data in the unlabeled data set based on the convolutional neural network module;
performing mask processing on the shallow representation result to obtain a mask representation result, and calculating a deep representation result of the mask representation result based on the convolutional enhancement module;
performing linear transformation on the shallow representation result to obtain a target representation result; and
calculating the contrastive learning loss function based on the deep representation result and the target representation result.

13. The non-transitory computer-readable storage medium according to claim 12, wherein performing mask processing on the shallow representation result to obtain the mask representation result comprises:
obtaining a seed sample frame by randomly selecting from the shallow representation result based on a random mask probability; and
obtaining the mask representation result by replacing a feature vector of continuous K frames subsequent to the seed sample frame in the shallow representation result with a learnable vector, wherein K is a positive integer.

14. The non-transitory computer-readable storage medium according to claim 12, wherein calculating the contrastive learning loss function based on the deep representation result and the target representation result comprises:
selecting M frames of anchor samples from a mask portion in the deep representation result as first samples, wherein M is a positive integer;
selecting M frames of anchor samples in one-to-one correspondence with the M frames of anchor samples in the first samples from the target representation result as second samples, and selecting S frames of negative samples as third samples, wherein S is a positive integer; and
calculating the contrastive learning loss function based on a similarity between the first samples and the second samples and a similarity between the first samples and the third samples.

15. The non-transitory computer-readable storage medium according to claim 9, wherein the second network comprises a feature deformation module.

16. The non-transitory computer-readable storage medium according to claim 9, wherein the method for training the speech recognition model further comprises:
obtaining audio sample data based on a preset audio sampling rate, and dividing the audio sample data into first audio samples and second audio samples;
obtaining the unlabeled data set by calculating audio feature matrices of the first audio samples; and
obtaining the labeled data set according to calculated audio feature matrices of the second audio samples and an obtained text labeling result of the second audio samples.

17. The electronic device according to claim 10, wherein the first network comprises a convolutional neural network module and a convolutional enhancement module.

18. The electronic device according to claim 17, wherein calculating the contrastive learning loss function based on the unlabeled data set comprises:
calculating a shallow representation result of a piece of audio sample data in the unlabeled data set based on the convolutional neural network module;
performing mask processing on the shallow representation result to obtain a mask representation result, and calculating a deep representation result of the mask representation result based on the convolutional enhancement module;
performing linear transformation on the shallow representation result to obtain a target representation result; and
calculating the contrastive learning loss function based on the deep representation result and the target representation result.

19. The electronic device according to claim 18, wherein performing mask processing on the shallow representation result to obtain the mask representation result comprises:
obtaining a seed sample frame by randomly selecting from the shallow representation result based on a random mask probability; and
obtaining the mask representation result by replacing a feature vector of continuous K frames subsequent to the seed sample frame in the shallow representation result with a learnable vector, wherein K is a positive integer.

20. The electronic device according to claim 18, wherein calculating the contrastive learning loss function based on the deep representation result and the target representation result comprises:
selecting M frames of anchor samples from a mask portion in the deep representation result as first samples, wherein M is a positive integer;
selecting M frames of anchor samples in one-to-one correspondence with the M frames of anchor samples in the first samples from the target representation result as second samples, and selecting S frames of negative samples as third samples, wherein S is a positive integer; and
calculating the contrastive learning loss function based on a similarity between the first samples and the second samples and a similarity between the first samples and the third samples.

21. The electronic device according to claim 10, wherein the method for training the speech recognition model further comprises:
obtaining audio sample data based on a preset audio sampling rate, and dividing the audio sample data into first audio samples and second audio samples;
obtaining the unlabeled data set by calculating audio feature matrices of the first audio samples; and
obtaining the labeled data set according to calculated audio feature matrices of the second audio samples and an obtained text labeling result of the second audio samples.
